(19) United States
(12) Patent Application Publication
(10) Pub. No.: US 2016/0140868 A1
(43) Pub. Date: May 19, 2016

(54) TECHNIQUES FOR USING AUGMENTED REALITY FOR COMPUTER SYSTEMS MAINTENANCE

(71) Applicant: NETAPP, INC., Sunnyvale, CA (US)

(72) Inventors: Stuart Lovett, Pittsburgh, PA (US); Brad Reger, Sunnyvale, CA (US); Allen Tracht, Pittsburgh, PA (US)

(73) Assignee: NETAPP, INC., Sunnyvale, CA (US)

(21) Appl. No.: 14/540,607

(22) Filed: Nov. 13, 2014

(51) Int. Cl. G09B 19/00; G01C 21/20; G06T 19/00

(52) U.S. Cl. CPC G09B 19/0053; G06T 19/006; G01C 21/206; G06T 2215/16

(57) ABSTRACT

Techniques for an augmented reality component are described. An apparatus may comprise an augmented reality component to execute an augmented reality service in a data system. The augmented reality service operative to generate an augmented reality view of one or more objects within a target location. The augmented reality service operative to receive spatial awareness information for at least one object. The augmented reality service operative to calculate a path to the at least one object within the augmented reality view. The augmented reality service operative to add a digital representation of the path to the augmented reality view to create a mapped augmented reality view. The augmented reality service operative to present the mapped augmented reality view on an electronic device.

### TECHNICAL FIELD

Embodiments described herein generally relate to using augmented reality for computer systems maintenance. In particular, embodiments relate to using an augmented reality of a target location of a computer system for directing a user to the geographic position of a target location.

### BACKGROUND

As computer networks have become faster and more reliable, the deployment of networks of computing environments has become more widespread. A data center is a dynamic environment used to house computers systems and associated computer components, such as telecommunications and storage systems. Data centers may provide one or more computers depending on the size of the data center environment. Some data centers may possibly house thousands of computers. Data centers may provide support for variety of system applications. By way of example only, data centers may comprise aisles of racks of computer equipment, such as servers and switches. The computing equipment installed on each rack in a particular aisle may need occasional servicing and maintenance. Identifying each specific computing device or component requiring maintenance or repair services is a challenge many data centers encounter. For example, accurate identification of a correct computing cable and port is critical as inadvertent removal of a wrong cable would lead to costly service disruption. Accordingly, a need exists for identifying the exact computing device requiring maintenance and/or repair without requiring manually installed service required tags or indicators.

### BRIEF DESCRIPTION OF THE DRAWINGS

FIG. 1A illustrates an embodiment of a data center.

FIG. 1B illustrates an embodiment of a system overview of a computing system in a data center.

FIG. 2 illustrates an exemplary embodiment of hardware architecture of a computing system in a data center.

FIG. 3 illustrates an embodiment of partial view of a physical mapping and a network mapping of a data center of FIGS. 1-2.

FIG. 4 illustrates an embodiment of using augmented reality of the physical mapping and a network mapping of a data center of FIG. 3.

FIG. 5 illustrates an embodiment of displaying the augmented reality of the physical mapping and a network mapping of a data center of FIG. 3.

FIG. 6 illustrates an embodiment of displaying the augmented reality with a work order and directions to a computer device of the physical mapping and a network mapping of a data center of FIG. 3.

FIG. 7 illustrates an embodiment of displaying the augmented reality history log of a data center of FIG. 3.

FIG. 8 illustrates an embodiment of a detailed logic flow for providing augmented reality of a data center of FIG. 3.

FIG. 9 illustrates an embodiment of a detailed logic flow for providing an augmented reality view of a physical mapping and a network mapping of a data center of FIG. 3.

FIG. 10 illustrates an embodiment of a computing architecture.

FIG. 11 illustrates an embodiment of a communications architecture.

### DETAILED DESCRIPTION

Various embodiments are generally directed to identifying an exact computing device for maintenance and/or repair in a data center using augmented reality. More specifically, various embodiments provide an augmented reality component to execute an augmented reality service for a target location. The augmented reality service provides an augmented reality view of the target location, such as the data center. The target location represents a physical geographic location. A target location generator, having management tools, builds and maintains the physical geographic location mapping and computer network mapping of the target location. The augmented reality is live direct or indirect viewing of a physical real-world environment of the data center whose elements are augmented by virtual computer-generated imagery.

The augmented reality service generates an augmented reality view of one or more objects within the target location. The one or more objects may be computer devices and each component or cable of the computer devices. The augmented reality service receives spatial awareness information for at least one object. The augmented reality service uses the spatial awareness for providing a mapping to a specific, geographic position within the target location. The mapping may be both passive and real-time active data. The spatial awareness may comprise a position in space and time, direction, and an orientation of one or more physical objects, such as computing devices and each individual component of the computer devices.

One or more objects may be identified for performing maintenance or service in the target location. The augmented reality service provides maintenance or service instructions for one or more objects in the mapped augmented reality view. For example, a work order for a computer device may be issued and provided in the mapped augmented reality view. Directions are provided to the one or more objects in the mapped augmented reality view. The augmented reality service calculates a path to the object (such as an object requiring maintenance or repair and/or is scheduled for maintenance or repair) within the augmented reality view. A digital representation of the calculated path is added to the augmented reality view to create a mapped augmented reality view. The directional path added to the augmented reality view may be one or more sets of patterns by illustrating the patterns in the screen space of the electronic device.

The mapped augmented reality view is presented on an electronic device, such as a laptop, mobile device, and/or computer. The augmented reality service uses the augmented reality of the target location to display on the electronic device the mapped augmented reality view of the target location for directing the user to a geographic position. The augmented reality component arranges and manipulates information of the physical geographic layout and network mapping of the target location for displaying the augmented reality view in the electronic device. For example, the augmented reality component provides a visually intuitive augmented reality arrangement of the physical layout and network mapping of the target location. More specifically, the augmented reality of the data center is provided to a portable electronic device's imaging and display capabilities and may combine a video feed with data describing objects in the video. In some examples, the data describing the objects in the video may be the result of a search for nearby points of interest.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter. It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

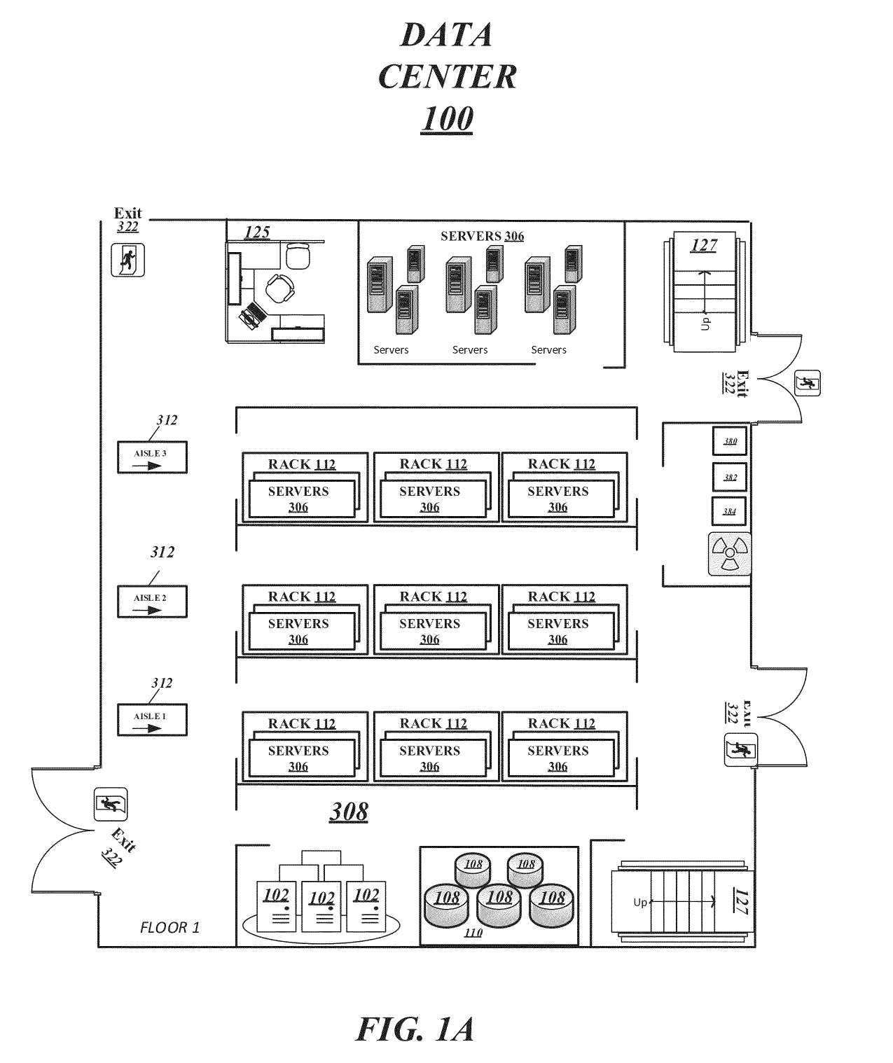

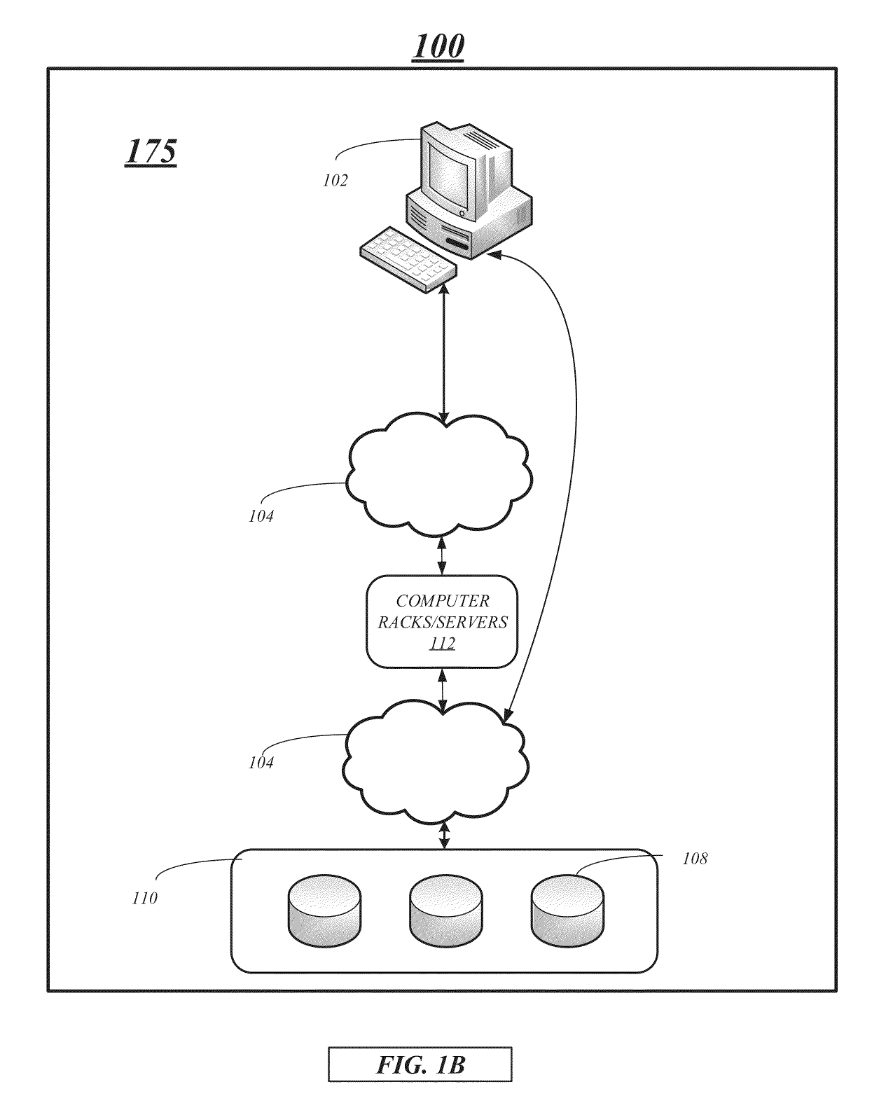

FIG. 1A illustrates an embodiment of a data center 100. FIG. 1B illustrates an embodiment of a system overview of a computing system 175 in a data center 100. In one embodiment, the computing system 175 may be a computer-networked system. The exemplary data center 100 may include a one or more computers 102, one or more networks 104 having one or more interconnects, computer racks and/or servers 112, and/or one or more storage arrays 110 having one or more storage devices 108. In one embodiment, the data center 100 may include each component, such as the one or more computers 102, or the data center 100 may include everything except the client/host computer 102. The data center 100 may be one of a variety of physical architectures having various computer equipment 302 and other physical features, such as a floor 308, stairs 127, exits 322, environmental sensors 380, warning systems 382, audio/visual equipment 384, visual signs 312, and/or other features and computing components.

In one embodiment, a storage array 110 may be located inside and/or remotely from the data center 100. In various embodiments, data center 100 may contain a clustered storage system in a storage area network (SAN) environment, such as the computer system 175. In one embodiment, the data center 100 may be a large facility housing one or more computers 102 and one or more racks 112 of computer servers 306, workstations 125, and/or one or more computer systems 175. For simplicity purposes, FIG. 1B only illustrates one computer 102 networked to one or more networks 104 having one or more interconnects, computer racks 112 and/or servers 306, and/or one or more storage arrays 110 having one or more storage devices 108 in the data center 100. However, data center 100 may have any number of computer devices 102, computer systems 175, and/or other computing architectures in the data center 100 as illustrated in FIGS. 1A-1B.

One or more computers 102 may be may be a general-purpose computer configured to execute one or more applications. Moreover, the one or more computers 102 may interact within the data center 100 in accordance with a client/server model of information delivery. That is, the one or more computers 102 may request the services of the computer racks/servers 112, and the computer racks/servers 112 may return the results of the services requested by the one or more computers 102, by exchanging packets over the network 104. The one or more computers 102 may issue packets including file-based access protocols, such as the Common Internet File System (CIFS) protocol or Network File System (NFS) protocol, over Transmission Control Protocol/Internet Protocol (TCP/IP) when accessing information in the form of files and directories. In addition, the one or more computers 102 may issue packets including block-based access protocols, such as the Small Computer Systems Interface (SCSI) protocol encapsulated over TCP (iSCSI) and SCSI encapsulated over Fibre Channel (FCP), when accessing information in the form of blocks. The one or more computers 102 may include remote access and client server protocols including secure shell (SSH), remote procedure call (RPC), XWindows, hypertext transfer protocol (HTTP), structured query language (SQL), and/or Hadoop®.

In various embodiments, network 104 may include a point-to-point connection or a shared medium, such as a local area network. In some embodiments, network 104 may include any number of devices and interconnect such that one or more computers 102 may communicate within the data center 100. Illustratively, the computer network 104 may be embodied as an Ethernet network or a Fibre Channel (FC) network. One or more computers 102 may communicate within the data center 100 over the network 104 by exchanging discrete frames or packets of data according to pre-defined protocols, such as TCP/IP, as previously discussed.

It should be noted that the data center 100 may contain one or more computers 102 that provide services relating to the organization of information on computers and/or components of computers, such as storage devices 108 or racks of computers 112. As will be discussed in more detail below, data center 100 may include a number of elements and components to provide storage services to one or more computers 102. More specifically, data center 100 may include a number of elements, components, and modules to implement a high-level module, such as a file system, to logically organize the information as a hierarchical structure of directories, files and special types of files called virtual disks (vdisks), or logical unit identified by a logic unit number (LUN) on the storages devices 108.

In some embodiments, storages devices 108 may include hard disk drives (HDD) and direct access storage devices (DASD). In the same or alternative embodiments, the storage devices (writeable storage device media) 108 may comprise electronic media, e.g., flash memory, etc. As such, the illustrative description of writeable storage device media comprising magnetic media should be taken as exemplary only.

Storage of information on storage array 110 may be implemented as one or more storage “volumes” that comprise a collection of storage devices 108 cooperating to define an overall logical arrangement of volume block number (vbn) space on the volume(s). The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

In some embodiments, the information on storage array 110 may be exported or sent to one or more computers 102 as one or more data structures such as a logical unit identified by logical unit numbers (LUNs). The LUN may be unique identifier used to designate individual or collections of hard disk devices for address by a protocol associated with a SCSI, iSCSI, Fibre Channel (FC), and so forth. Logical units are central to the management of block storage arrays shared over a storage area network (SAN). Each LUN identifies a specific logical unit, which may be a part of a hard disk drive, an entire hard disk or several hard disks in a storage device, for example. As such, a LUN could reference an entire RAID set, a single disk or partition, or multiple hard disks or partitions. The logical unit is treated as if it is a single device and is identified by the LUN.

It should be noted the description of the various methods, components, and systems of the data center 100 in FIGS. 1A-1B illustrates one type of data center 100 and associated workflow. Given the vast array of the types of computers, computer networks, and devices that may be housed within the data center 100, the present disclosure may be applicable to any type of data center having various workflows, networks, communication systems, protocols, computers and computer components, with each data center 100 functioning and operating the same or different than another data center. Also, it should be noted that multiple data centers 100 may be combined into one larger data center 100. The data centers 100 may be located in one or more geographical locations. For example, in an alternative embodiment, data center 100 may occupy one room of a building, one or more floors 308, or an entire building. The equipment of the data center 100 may be in the form of servers mounted in rack cabinets 112, which are usually placed in single rows forming corridors (so-called aisles 312) between them. This allows access to the front and rear of each cabinet 112. The servers may differ size from one rack unit (1U) server to large freestanding storage silos that occupy many square feet of floor space. Some equipment, such a mainframe computer and storage devices 108 may be as large as the racks 112 themselves, and are placed alongside them. Some data centers 100 may use shipping containers packed with 1,000 or more servers 306 each. When repairs or upgrades are needed, the entire container may be replaced (rather than repairing individual servers).

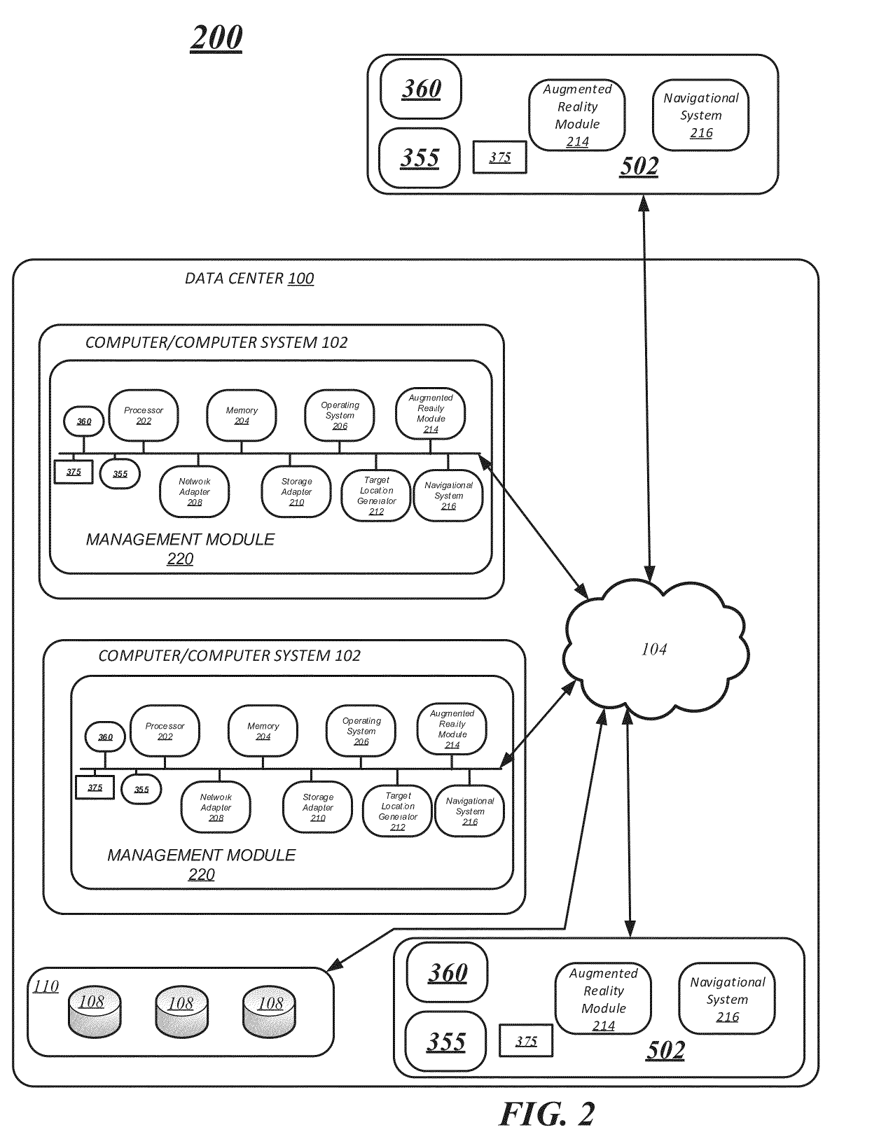

FIG. 2 illustrates an exemplary embodiment of hardware architecture 200 of a management module 220 in a data center 100. The data center 100 may include one or more computers 102, one or more networks 104 having one or more interconnects, with the computers and computer racks and/or servers 112, and/or one or more storage arrays 110 having one or more storage devices 108. The management module 200 may be stored or used on one or more the computers 102 of FIG. 1 or one or more of the servers on the racks of servers 112 of FIG. 1. The data center 100 may include a management module 220 having a processor 202, memory 204, storage operating system 206, network adapter 208, and storage adapter 210. The management module 220 may also include an augmented reality module 214 and a target location generator 212. The target location generator 212 is also referred to as a data center generator 212 and may be housed in a data center database. In one embodiment, the target location generator 212 includes a data center database and includes management tools. In various embodiments, the components of the management module 220 may communicate with each other via one or more interconnects, such as one or more traces, buses, and/or control lines. Also, the augmented reality module 214 includes and/or is in communication with a navigational system 216 for receiving information of the data center and/or users within the data center, including a target location corresponding to a point of interest in space, and a source location corresponding to a spatially enabled display. The augmented reality component 214 includes and/or associates with the navigational system 216 for receiving information of the data center 100, including the target location corresponding to a point of interest in space, and a source location corresponding to a spatially enabled display. It should be noted that the augmented reality module 214 and the navigational system 216 may be remotely located from the data center 100 and may be physically located on an electronic device 502, such a portable electronic device (e.g., laptop computer, tablet, smartphone, augmented reality glasses or goggles, etc.). In one embodiment, the augmented reality module 214 and the navigational system 216 may be remotely located on a computer system that is in communication with both the data center 100 and the electronic device 502. In one embodiment, the electronic device 502 communicates bi-directionally with the augmented reality module 214 and the navigational system 216 to determine and confirm the augmented reality view of the data center 100 (or any computer or component in the data center) is properly aligned to the mapping in one or more rooms of the data center 100. In one embodiment, the augmented reality module 214 and the navigational system 216 may transmit location information with the electronic device 502 receiving the transmitted location information. The electronic device 502 displays the appropriate augmented reality view of the data center 100 based on the location and the mapping. The electronic device 502, having an application for the augmented reality, communicates with the augmented reality module 214 and the navigational system 216 to obtain location information. The electronic device 502 associates the obtained location information with the mapping and calculates the path and displays the augmented reality view.

Processor 202 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. In various embodiments, management module 220 may include more than one processor.

In one embodiment, management module 220 may include a memory unit 204 to couple to processor 202. Memory unit 204 may be coupled to processor 202 via an interconnect, or by a dedicated communications bus between processor 202 and memory unit 204, as desired for a given implementation. Memory unit 204 may be implemented using any machine-readable or computer-readable media capable of storing data, including both volatile and non-volatile memory. In some embodiments, the machine-readable or computer-readable medium may include a non-transitory medium. The embodiments are not limited in this context.

The memory unit 204 can store data momentarily, temporarily, or permanently. The memory unit 204 stores instructions and data for management module 220. The memory unit 204 may also store temporary variables or other intermediate information while the processor 202 is executing instructions. The memory unit 204 is not limited to storing the above-discussed data; the memory unit 204 may store any type of data. In various embodiments, memory 204 may store or include operating system 206. In various embodiments, management module 220 may include operating system 206 to control operations on the management module 220. In some embodiments, operating system 206 may be stored in memory 204 or any other type of storage device, unit, medium, and so forth.

The network adapter 208 may include the mechanical, electrical and signaling circuitry needed to connect the management module 220 to one or more hosts and other storage systems over a network, which may comprise a point-to-point connection or a shared medium, such as a local area network.

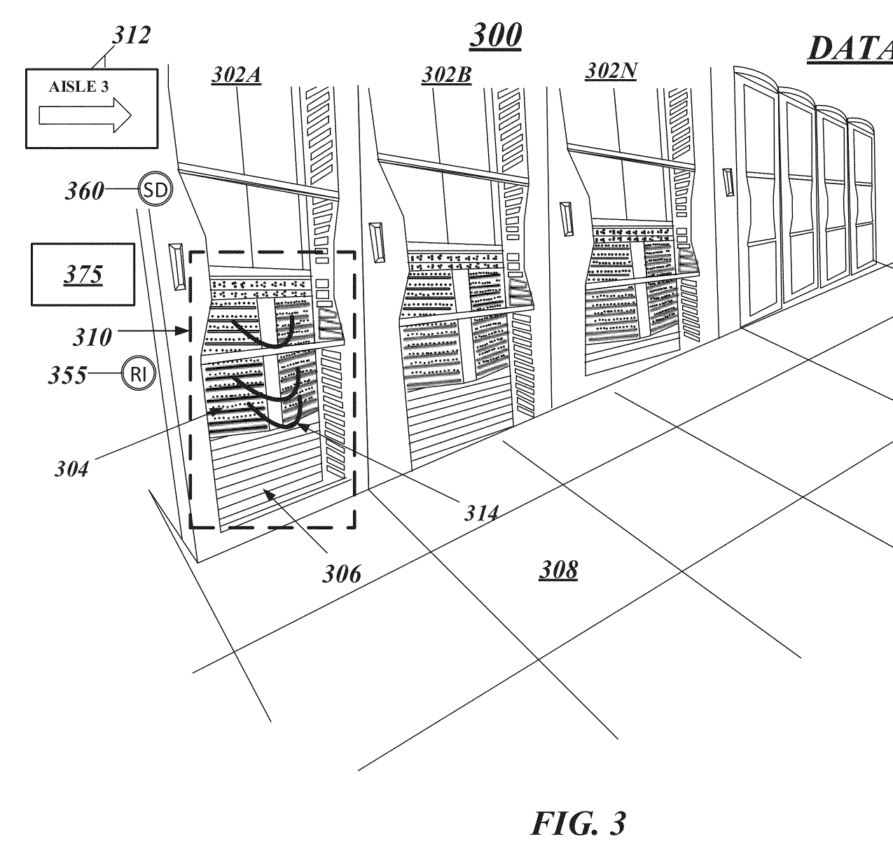

In various embodiments, the storage adapter 210 cooperates with the operating system 206 executing on the management module 220 to access information requested by a host device, guest device, another storage system, and so forth. The information may be stored on any type of attached array of writable storage device media such as video tape, optical, DVD, magnetic tape, bubble memory, electronic random access memory, micro-electro mechanical, and any other similar media adapted to store information, including data and parity information. Further, the storage adapter 210 includes input/output (I/O) interface circuitry that couples to the disks over an I/O interconnect arrangement, such as a conventional high-performance, FC serial link topology. In one embodiment, the electronic device 502 is connected via any networked communication, such as wirelessly connected, to the management module 220. In one embodiment, the electronic device 502 may include one or more management modules 220 with each management module 200 in communication with other management modules 220 installed on the electronic device, the data center 100, and/or other electronic devices 502. Also, the management module 220 and the electronic device may include and/or be in association with one or more reference indicators 355, sensors 360, environmental sensors 380, warning systems 382, audio/visual equipment 384, and/or visual signs 312 (see FIG. 3) as described herein.

FIG. 3 illustrates an embodiment of a partial view of a partial physical mapping and a network mapping 300 of a data center 100 of FIGS. 1-2. The data center 100 includes a physical mapping and a computer network mapping (herein after collectively referred to as “mapping”). In one embodiment, the mapping 300 is of the entire physical area of the data center 100 and/or a mapping of all computer networks and virtual computing systems. It should be noted that given the various sizes, dimensions, and design of each different type of data center 100, FIG. 3 illustrates a partial view of one aisle 312 of one or more racks 112 of one or more servers 306 in a data center 100. FIG. 3 depicts only a partial view of an entire mapping of a physical section of a data center 100 and should not be viewed or interpreted as limiting the entire physical mapping and computer network mapping of the data center 100 as described herein. The mapping 300 may be a holographic, two-dimensional (2D) and/or a three-dimensional (3D) representation of the data center 100 and each computer device 302. The network mapping provides a “component-level” map of each computer device 302A-N (illustrated collectively as “302”) and each component of the computer device 302 installed in the data center 100. The “component-level” map is more clearly illustrated using a partial view 310 of the network mapping on a computing device 302, such as a partial view of one of the racks 112 having one or more servers 306. The mappings 300 of the physical geographic layout and the computer networks may be combined as one data center map 300 designed from the management tools of the target location generator 212 as used in the augmented reality. In other words, the mapping may provide one or more multiple layers of the mapping. For example, the mapping 300 may provide a physical data center layer showing an architectural layout of the data center 100. The mapping 300 may have a computer network layer showing each computer and computer component of a computer system in the data center 100. The mapping 300 may also have “micro-layers” of individual mapping layers for each room, floor, aisle, rack, server, and computer. Each of these layers may be manipulated and selected by the user to be displayed in an augmented reality view using the electronic device 502 in communication with the augmented reality component 214 and the management module 220. In one embodiment, the mapping 300 contains each and every layer. In alternative embodiments, one or more layers are displayed in an augmented reality view on an electronic device 502. Data related to the data center 100 may also be illustrated in the augmented reality view of the mapping. For example, the location of each piece of equipment and/or date of purchase and installation of each computer component may be displayed as a result of a search query by the user. Another example includes displaying the various applications or software versions of the computer systems displayed in the augmented reality. Temperature, elevations, safety codes, building codes, fire alarms, exits, hazardous areas, and other data relating to the data center 100 may be integrated and displayed with the mapping in the augmented reality view.

One or more sensors 360 using one or more communication technologies may assist in the mapping and for communicating spatial awareness information. The sensors 360 may be located in the data center 100 and include accelerometers for orientation and for dead reckoning from reference locations. The sensors 360 may also include magnetometers for orientation and optical labels for reference location, such as bar codes and blinking LEDs. The sensors 360 assist in identifying the target location in the data center 100. Once the augmented reality module 214 determines and knows the position and orientation of the target device, the augmented reality module 214 may provide an augmented reality view of the mapping 300 for directing a user 350 to the target location. The augmented reality module 214 may also illustrate in the augmented reality view how to access, service, and/or repair the computing device 302 and any other information relating to the computing device 302 needing service or repair.

In one embodiment, reference indicators 355, including visible and RF-ID labels, visible-light, invisible-light (infra-red), ultrasonic, and radio-frequency beacons are located throughout the data center 100. The accelerometers and magnetometers for orientation and dead reckoning, as well as sensors 360 for identifying the reference indicators 355 and their location relative to the electronic device 502 may be part of the electronic device 502. These sensors 360 include still and video cameras (for the visible labels and visible- and invisible-light beacons), RF-ID readers, microphones, and radio-frequency antennas and receivers.

The mapping 300 of the data center 100 also provides for the identification of the computer devices and components in photographs or videos of the installed computer equipment 302. The sensors 360, may also be employed to accurately identify the locations of the identified computer equipment 302. Machine-readable tags or time-domain devices may also be used in the augmented reality to aid in identification and location detection for a variety of computers and computer components. For example, each computing device may include a bar code to be displayed as a photograph or video in the augmented reality for identification and detection. Also, each computing device may include a pattern of one or more visible or infrared light-emitting diodes (LEDs) that may blink or illuminate and be displayed in the augmented reality view.

It should be that FIG. 3 is only one exemplary embodiment of a data center 100. The data center 100 may include a variety of types of computer systems 175. These computer systems may include various computer networks and associated components. For example, the data center 100 may provide redundant and backup battery supplies, data communication connections, and/or small and large-scale control systems. The data center 100 may be one or more of a variety of types of physical housing (e.g., buildings) having one or more levels, aisles, and/or design configurations. As such, each data center 100 may be arranged and configured with one or more computer devices/networks 175, 175 and design configurations not shown in FIG. 3, according to desire preferences and need.

For example, FIG. 3 illustrates the mapping 300 of the data center 100 having several racks of computer equipment 302 in an aisle 312, such as aisle 3, of a data center 100. The racks of computer equipment 302 may be servers or other various computing systems. For illustration purposes, the racks 112 of computer equipment 302 in FIG. 3 include a number of servers 306. The physical mapping may include the physical geographic location of the computer equipment 302 and other physical features, such as a floor 308, an exit 322, environmental sensors 380, warning systems 382, audio/visual equipment 384, visual signs 312, and/or other features and computing components.

A partial view 310 (see lines 310 of FIG. 3) of the network mapping is illustrated using the lines 310 showing the various computing components such as ports 304 and one or more cables 314 of the servers 306. The network mapping may identify cable connections between devices. The cables of the cable connections may be electrical or optical cables. Also, computer device level and computer system level inventory tools of the target location generator 212 and augmented reality component 214 identify computer devices 302 maintainable for service and maintenance. For example, the computer device level and computer system level inventory tools of the target location generator 212 and augmented reality component 214 may identify optical transceivers and/or disk drives within a chassis.

In one embodiment, the mapping 300 may be static and generated at the time each computer device is installed in the data center 100. The mapping 300 of the data center 100 may also be updated as changes occur in the data center 100. In an alternative embodiment, the mapping 300 of the data center 100 may be dynamic and generated at the time of maintenance or repair. However, the creation of the mapping 300 of the data center 100 may be both static and dynamic. For example, the physical layout of the computer devices 302 may be explicitly mapped at the time of installation while the network mapping may be mapped at the time of maintenance or repair.

The embodiments are not limited to this example.

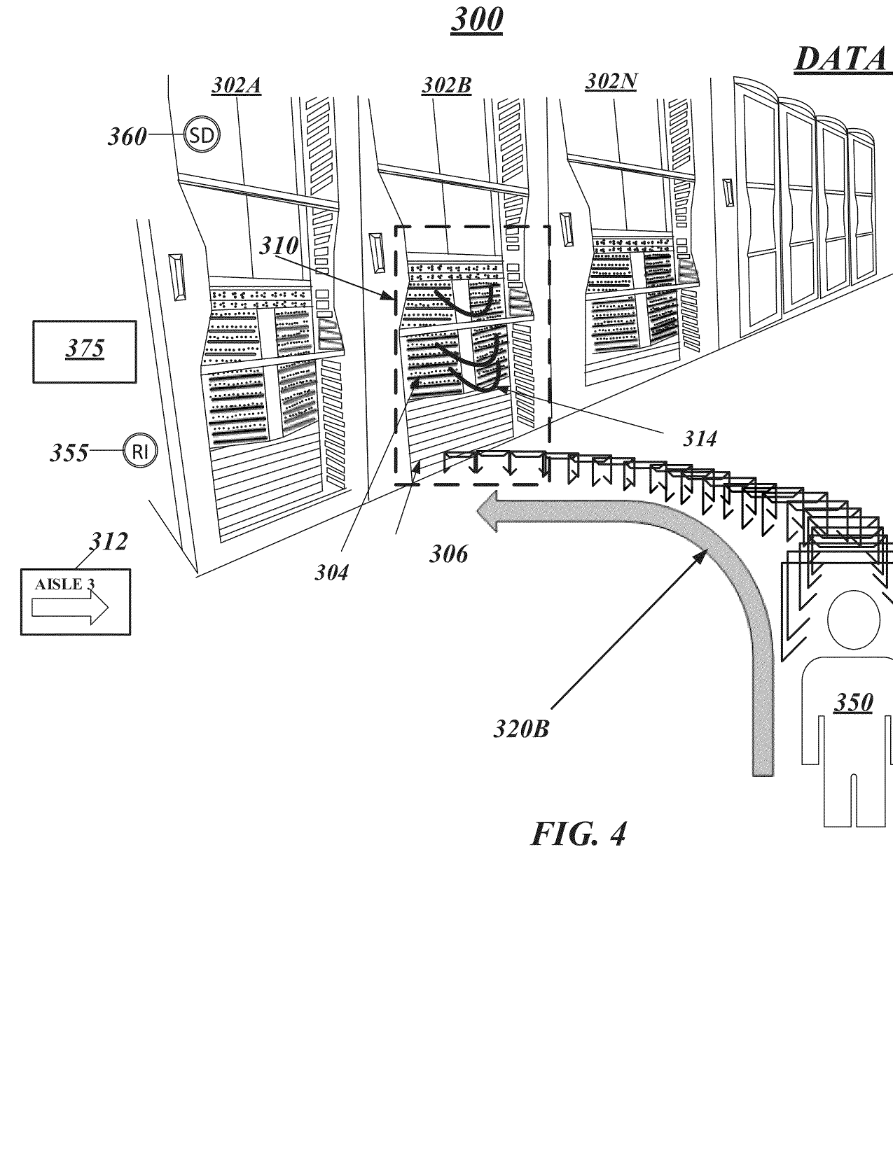

FIG. 4 illustrates an embodiment of using augmented reality of the physical mapping and a network mapping 300 of a data center 100 of FIGS. 1-3 In one embodiment, the augmented reality module 214 determines the spatial awareness, such as location and orientation, at any given time in the data center 100 using one of a multiplicity of spatial awareness devices 375. The augmented reality module 214 and/or the navigational system 216 may determine the spatial awareness information using one or more of spatial awareness devices 375 for at least one object. The physical mapping may include the physical geographic location of the computer equipment 302 and other physical features, such as a floor 308, an exit 322, environmental sensors 380, warning systems 382, audio/visual equipment 384, visual signs 312, and/or other features and computing components. In one embodiment, reference indicators 355, including visible and RF-ID labels, visible-light, invisible-light (infra-red), ultrasonic, and radio-frequency beacons are located throughout the data center 100. The accelerometers and magnetometers for orientation and dead reckoning, as well as sensors 360 for identifying the reference indicators 355 and their location relative to the electronic device 502 may be part of the electronic device 502. These sensors 360 include still and video cameras (for the visible labels and visible- and invisible-light beacons), RF-ID readers, microphones, and radio-frequency antennas and receivers.

For example, the spatial awareness devices 375 may include or be in communication with or association with the navigational system 216, having a tracking device and/or a global positioning satellite (GPS) device, the sensors 360, and/or the reference indicators 355. In one embodiment, the navigational system 216 is installed on the spatial awareness devices and/or the navigational system 216 may be in communication with each spatial awareness device, sensors 360, environmental sensors 380, warning systems 382, audio/visual equipment 384, visual signs 312, and/or other features and computing components. In one embodiment, the spatial awareness devices 375 include a tracking device, a GPS device, the sensors, and/or reference indicators.

The spatial awareness devices 375, the sensors 360, and/or the reference indicators 355 may include radio frequency identification (RFID) devices or tags, a machine vision mechanism, a bar code, and electric-field sensing component, a gesture recognition device, a head tracker, an eye tracker, infra-red light-emitting diodes (LEDs), and a motion detection device, or other devices used for determining location, orientation, position, and/or geometric configuration. One or more spatial awareness devices 375 may be remotely located for the target location on a device or application of an electronic device 502, such as a portable electronic device (e.g., laptop or computer). One or more spatial awareness devices 375 may be installed in one or more locations of the target location in the data center 100.

For example, one or more spatial awareness devices 375 may be used simultaneously and in conjunction with each other. For example, the spatial awareness devices 375 may include and/or be in communication with the navigational system 216, and/or may include a tracking device, one or more GPS satellites, and one or more items with different RFID tags or bar codes installed on each electronic device 502, computer device 302, computer component 306, and/or other locations of both a computer system level and a computer component level. The navigational system 216 and/or tracking device in association with the navigational system, may include a GPS interface for communicating with the one or more GPS satellites and obtaining GPS coordinates. The tracking device may relay to and store in the management module 220 (using the individual components of the management module 220, such as the augmented reality module 214 and the navigational system 216), the RFID tag or bar code information associated with one or more computer devices 302 and/or computer components 306 in the data center 100. The tracking device may also store in the management module 220 well as a description and other information of the computer devices 302 and/or the computer components 306 and an associated GPS location that includes GPS coordinates for a vicinity of the computer devices 302 and/or the computer components 306 is located. The tracking device may also store a description of a location associated with the GPS location.

The augmented reality module 214 and/or the navigational system 216 may also determine and/or assist in determining both a position and orientation of a user relative the one or more objects in the target location using one or more of the spatial awareness devices 375. The augmented reality module 214 integrates inputs from a number of sensors 360 using one or more communication technologies. The communication technologies may include but are not limited to global positioning satellite (GSP), Bluetooth, and/or WiFi wireless network. The sensors 360 may be located in one or more positions in the data center 100 and include accelerometers for orientation and for dead reckoning from reference locations.

In one embodiment, the augmented reality module 214 illustrates all of the mapping 300 and/or a portion of the mapping 300 in either two-dimensional (2D) or three-dimensional (3D) and overlaid on a real-time video image of the data center 100. The mapping 300 showing a current location of a user 350 relative to the target location while correctly orienting a user 350 for easy navigation to the target location. For example, the augmented reality module 214 provides a heads-up display (HUD) in the augmented reality of the mapping 300 where the augmentation is added to the user's 350 direct view of the data center 100 using a semi-transparent mirror or display, which may be implemented using specialized glasses or head gear.

The augmented reality creates and calculates a directional path 320 for guiding a user to one or more computer devices 302 or components 306 (e.g., a port on a server, a cable, etc.) for performing maintenance or service (such as those computer devices 302 requiring or scheduled for maintenance or service). The directional path 320 may be one of a variety of types of directional paths, such as a set of patterns 320A and a directional arrow 320B. The directional path 320 may be a plane pattern with a virtual sight and/or target location in the center of the virtual sight or center of the directional path 320. The directional path 320 may roll and curve along with the user 350 as the user 350 is moving towards or away from the direction of the target location. The target location may remain in the center of the directional path during movement by the user 350.

For example, directional paths 320A, 320B indicate a direction to the target location, such as computer component 302B, and indicate the target location orientation relative to the user 350. The orientation and spatial awareness of each pattern along the directional path 320 is obtained by a spherical linear interpolation of the up direction of a user frame and the up direction of the target location frame. The azimuth and elevation of the pattern of the directional path 320 may also be determined using the spatial awareness of the data center 100. The directional paths 320A, 320B allows for the user 350 to traverse the directional paths 320A, 320B to the target location, such as computer device 302B. Hence, the directional paths 320A, 320B may be built from multiple directional path segments influenced by GPS navigation information. The directional paths 320A, 320B may execute a roll and curve computation according to directional paths segments for positively orienting the user in initial and final traversal phases along the directional paths 320A, 320B.

In one embodiment, directional paths 320A, 320B may include both attention and navigation directions. For example, the directional paths 320A, 320B may be a curve, straight line, or series of 3D objects or illustrations that directs attention and/or navigates the user to the target location 504, even when the target location is at a considerable distance or obscured from a viewpoint of the user 350. The directional paths 320A, 320B may be built from multiple directional paths segments influenced by GPS navigation information. A roll computation may be designed according to directional paths 320A, 320B segments positively orienting the user 350 in the initial and final traversal phases. Attention is visually directed to the target location in a natural way that provides directions in 3D space. A link to the target location using the directional path 320 may be followed rapidly and efficiently to the target location regardless of the current position of the target location relative to the user 350 or the distance to the target location 504. The directional path 320 of the augmented reality of the data center 100 connects the user 350 directly to a cued target location, such as computer device 302B. The target location may be anywhere in near or distant space around the user 350.

Thus, the augmented reality module 214 may be designed with perspective cues to draw perspective attention to the depth and center and link the target location 504 to the head or viewpoint of the user 350. Attention cues may be activated by the management module 220 and provide for alerts, or guides such as “you have turned down aisle 3 and are 30 feet away from the target location.” Also, the attention cues may be provided by the user 350 for activating a remote request using an electronic device in communication with the augmented reality module 214. For example, the user 350 may be oriented in the data center 100 and at a location not identified as the target location and request the augmented reality module 214 to indicate those computer devices in a predetermined range (e.g., as set forth by the user) for service or repair within a particular time period. The augmented reality module 214 in association with the management module 220 prominently displays in the electronic device 502 the augmented reality view those computer devices 302 for performing maintenance or service (such as those computer devices 302 requiring or scheduled for service) with the requested time period.

In one embodiment, the management module 220 monitors the performance states of each computer device and computer component in the data center 100. For example, the management module may detect a fault condition or a potential fault condition of a computer or component. The management module 220 processes this detected performance state and communicates with processed information to the augmented reality module 214. The augmented reality module 214 analyzes and processes the received information and generates an alert. The management module 220, the navigational system 216, and the augmented reality module 214 work in conjunction to track the location of the user 350 while the user 350 is traversing along the calculated path. When the user is within a defined proximity to one or more computers or components being monitored by the management module 220, the alert (e.g., an audio and visual alert) may be dynamically and automatically sent the electronic device 502 notifying the user 350 of the performance state of one or more computers or components being monitored. As such, the user 350 may issue a response notification requesting historical data, such as maintenance records, software versions, augmented reality log data, and other information relating to the one or more computers or components pertaining to the alert.

It should be noted that instructions for repair and required materials or tools may also be provided to the user 350 in the augmented reality. For example, if a cable is detected as in need of repair, the size of the cable, the type of cable, and manufacturer data may also be displayed. Also, the management module 220 may be in communication with the “outside world” and provide real-time active information relating to repair and or maintenance of the computer or computer component. For example, the management module 220 may gather and collect service data from the manufacturer and relay such data to the augmented reality module 214. The augmented reality module 214 processes and analyses this received data and may selectively display the processed data in the electronic device the augmented reality view. For example, a manufacturer of the defective cable's website link and/or contact and/or order forms may be provided along with the path and the mapping 300 in the augmented reality view on the electronic device.

The augmented reality module 214 in association with the management module 220 retains all historical data, maintenance records, work orders, and/or service requirements associated with each computing device 302 within the data center 100. Moreover, the augmented reality module 214 in association with the management module 220 records all directions, alerts, video, audio, and/or movements and activities of the data center 100, such as maintaining a log history of the movements of a user 350 following the directional paths 320A, 320B in the data center 100.

For example, the augmented reality module 214 in association with the management module 220 provide notification of the user of an emergency, such as a fire detected by the environmental sensors 380, and then providing guidance to the appropriate exit 322 with the assistance of environmental sensors 380 and/or audio/visual systems in communication with the augmented reality module 214 and the management module 22. Audio guidance, based on the current position and direction of travel (e.g., “turn left”, “keep going”) would allow safe navigation when smoke obscures visible cues.

The embodiments are not limited to this example.

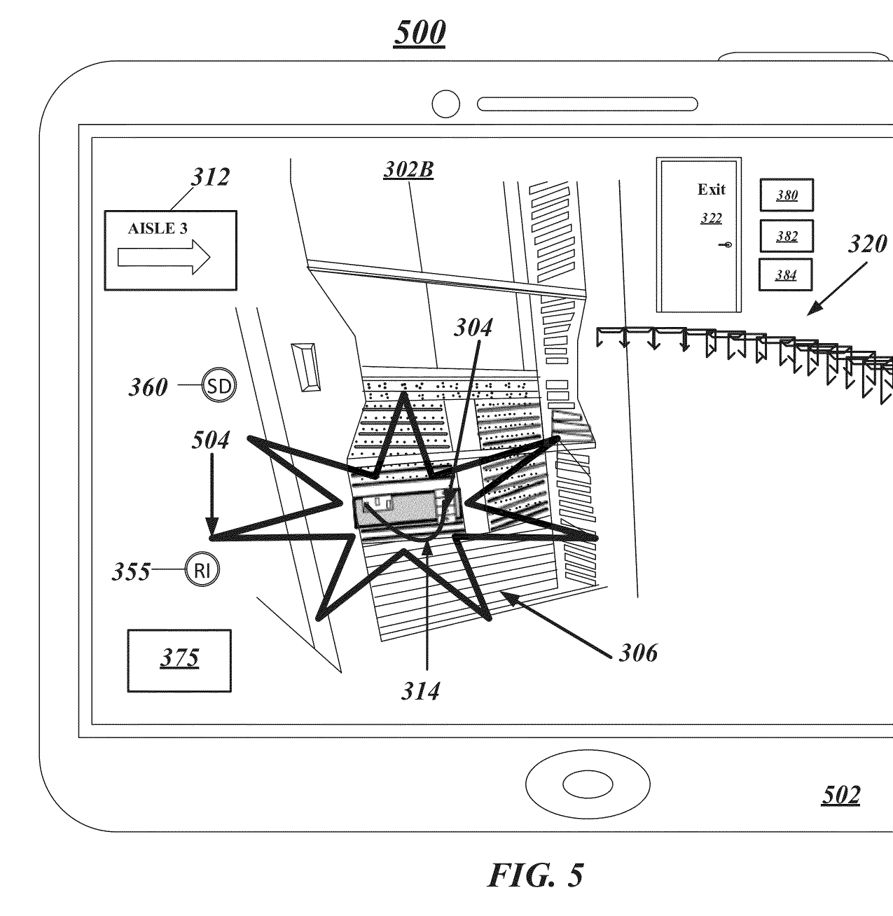

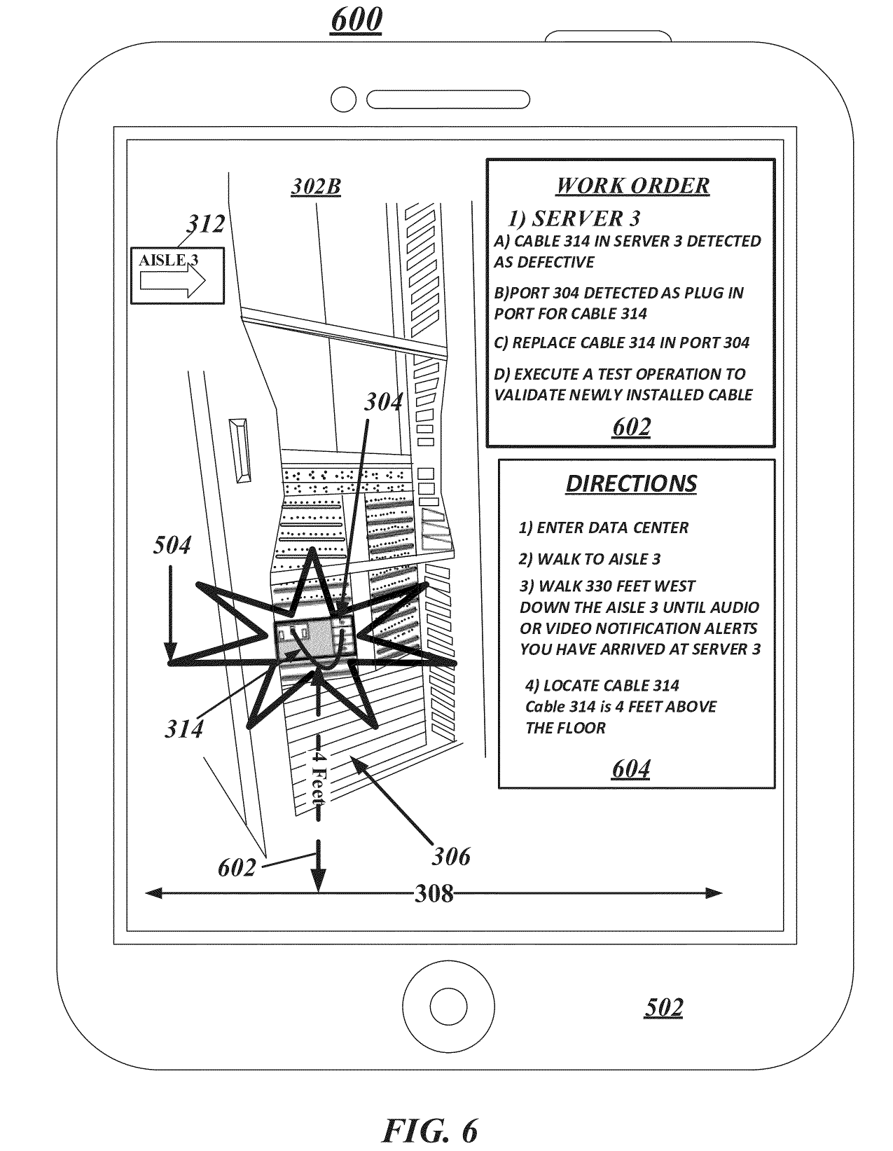

FIGS. 5-6 illustrates embodiments 500, 600 displaying the augmented reality of the mapping in an electronic device 502 of a data center 100 of FIGS. 1-3.

The electronic device 502 may include processor 102. In various embodiments, electronic device 502 may include more than one processor.

In one embodiment, electronic device 502 may include a memory unit 204 to couple to processor 202. Memory unit 204 may be coupled to processor 202 via an interconnect, or by a dedicated communications bus between processor 202 and memory unit 204, as desired for a given implementation. Memory unit 204 may be implemented using any machine-readable or computer-readable media capable of storing data, including both volatile and non-volatile memory. In some embodiments, the machine-readable or computer-readable medium may include a non-transitory medium. The embodiments are not limited in this context.

The memory unit 204 can store data momentarily, temporarily, or permanently. The memory unit 204 stores instructions and data for electronic device 502. The memory unit 204 may also store temporary variables or other intermediate information while the processor 202 is executing instructions. The memory unit 204 is not limited to storing the above-discussed data; the memory unit 204 may store any type of data. In various embodiments, memory 204 may store or include operating system 206. In various embodiments, electronic device 502 may include operating system 206 to control operations on the electronic device 502. In some embodiments, operating system 206 may be stored in memory 204 or any other type of storage device, unit, medium, and so forth.

The network adapter 208 may include the mechanical, electrical and signaling circuitry needed to connect the electronic device 502 to one or more hosts and other storage systems over a network, which may comprise a point-to-point connection or a shared medium, such as a local area network.

In various embodiments, the storage adapter 210 cooperates with the operating system 206 executing on the electronic device 502 to access information requested by a host device, guest device, another storage system, and so forth. The information may be stored on any type of attached array of writable storage device media such as video tape, optical, DVD, magnetic tape, bubble memory, electronic random access memory, micro-electro mechanical, and any other similar media adapted to store information, including data and parity information. Further, the storage adapter 210 includes input/output (I/O) interface circuitry that couples to the disks over an I/O interconnect arrangement, such as a conventional high-performance, FC serial link topology. In one embodiment, electronic device 502 may be in association with management module 220.

FIG. 5 displays the augmented reality of the mapping 300 of a data center 100 having a directional path 320 to the target location 504 in an electronic device 502, such as a laptop, tablet, or mobile device. FIG. 6 similarly displays the augmented reality of the mapping 300 of a data center 100 but includes a work order 602 and directions 604 to the computing device 302 requiring service or maintenance. In FIGS. 5-6, the electronic device 502 and/or the management module 220 detects the geographical position of a target location 504. In FIGS. 5-6, the target location 504 (illustrated with the highlighted portion) is identified as the cable 314 plugged into port 304 of server 306. The cable 314 is detected as in need of repair or maintenance. It should be noted that the target location 504 may include the computer device and/or computer components in need of repair or maintenance. Also, any computer device and/or computer components associated with the computer device and/or computer components in need of repair or maintenance may be identified as a target location 504 if necessary.

The target location 504 (or more specifically, the computer devices 302 or computer components 306 requiring or scheduled for maintenance or service) is displayed more prominently using one of a variety of features in the augmented reality. For example, cable 314 plugged into port 304 of server 306 may be blinking or highlighted in the augmented reality as displayed in the electronic device 502. The directional paths 320 indicate the direction to the target location 504, such as cable 314, and target location 504 orientation relative to the user 350.

As seen in FIG. 6, a work order 602 is issued along with directions 604 to the target location 504 in the data center 100. The management module 220 having maintenance tools converts a maintenance operation or service operation into a work order that includes the work to be performed and associated information relating to the maintenance operation or service operation, such as the materials or tools necessary to perform the work. The maintenance tools in the management module 220 assist in identifying and detecting those computer devices 302 for performing maintenance or service (such as those computer device 302 requiring or scheduled for maintenance or service). For example, a defective cable 314 may detected by the sensors 360 in the data center 100 and the maintenance tools in the management module 220. Upon immediate detection of the defective cable 314, the management module 220 automatically issues one or more work orders.

The work order 602 may also include the location to the target device in a format understood by the augmented reality module 214 for display in the augmented reality of the data center 100. For example, the format for the location to the target device may be displayed by directions 604 associated with the work order 602.

The work order 602 and the directions 604 are included by the augmented reality module 214 and displayed in an augmented realty of the mapping of the data center 100 in the electronic device 512. For example, in FIGS. 5-6, the work order 602 indicates that cable 314 is detected as defective and is connected to port 304 of server 304. The work order 602 calls for the replacement of cable 314 in port 304. A test operation is also requested to validate a newly installed cable 314. Similar work orders and orders for repair, replacement, and testing may be included and/or displayed in the augmented reality. The directions 604 may include directions to enter the data center 100 and begin following the directional path 320 by moving in an identified aisle or row, such as aisle 312, and continuing the movement until reaching the target location 504 identified as cable 314. In one embodiment, the target location 504 may also include the orientation and geographical position in the augmented reality of the mapping 300. For example, in FIG. 6 the augmented reality illustrates the geographical position 602 by indicating the cable 314 is 4 feet from the floor 308 of the data center 100. Any type of geographical position coordinates or information may be selected by the user 350 for display. As the user 350 traverses along the directional path 320, the user's 350 geographical positions and the next set of direction to follow may be both visually displayed and/or audible communicated to the user via the electronic device. The geographical positions may include both latitude and longitude coordinates.

In one embodiment, the augmented reality module 214 may be in communication with an electronic image capturing device (e.g., camera) and/or audio capturing device (e.g., recorder) of the electronic device 502 used by the user 350. The augmented reality module 214 may receive, collect, and store any digital image to be used in real-time for immediate display in the augmented reality of the mapping 300. Thus, the augmented reality module 214 allows for a user 350 to enter the data center 100 and capture one or more images of the data center 100. Using the augmented reality of the mapping of the data center 100, the augmented reality module 214 may process the captured image and any associated request or command. The augmented reality module 214 then provides updated, real-time augmented reality information requested or provided by the user 350. For example, the user 350 may capture an image of a set of computer devices 302. The image is sent to the management module 220 with a request to highlight any servers having any service repairs performed in the last week. The management module 220 and augmented reality module 214 process and analyze the image and user request. The management module 220 and augmented reality module 214 may then provide an augmented reality of the mapping towards all target locations of computer devices 302 that have had any service repairs performed in the last week.

The embodiments are not limited to this example.

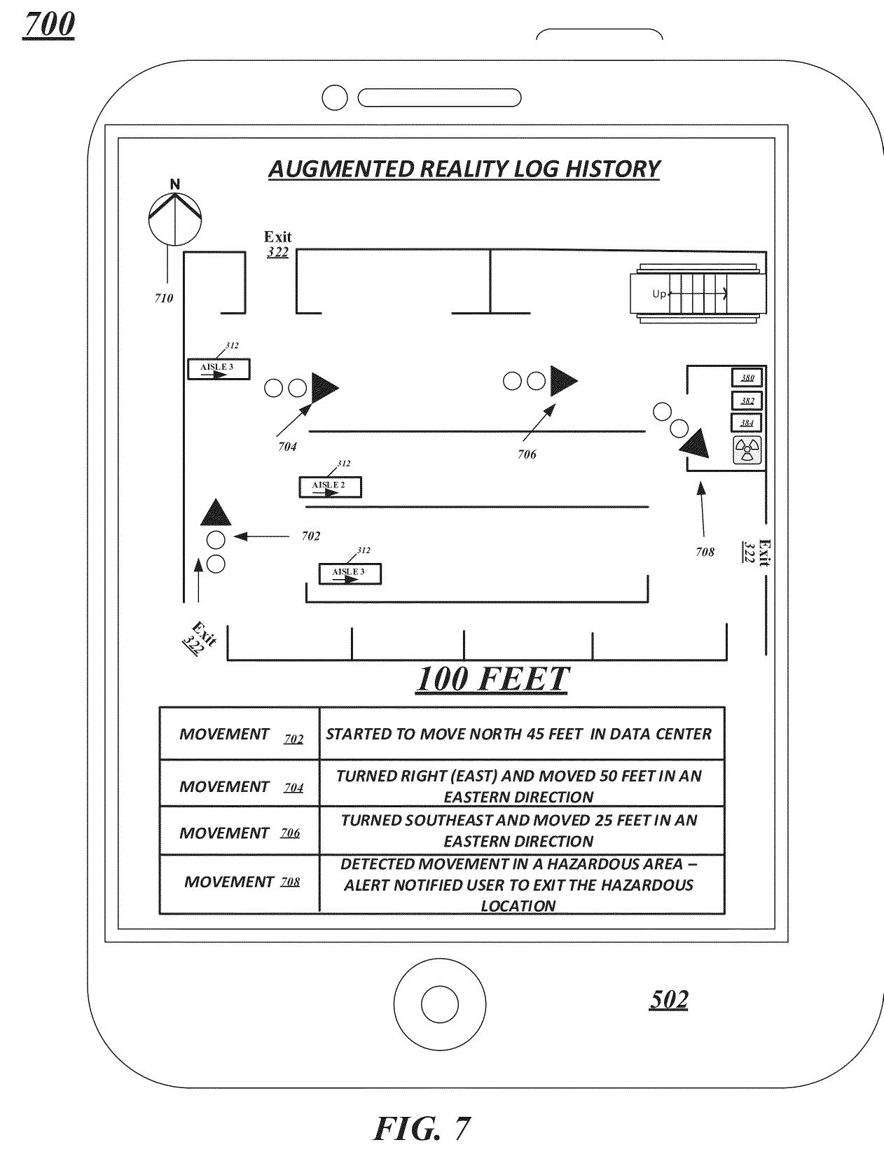

FIG. 7 illustrates an embodiment of displaying the augmented reality history log 700 of a data center of FIGS. 1-3. FIG. 7 displays in an electronic device 502 the augmented reality history log 700 of user 350 in the data center 100. For illustration purposes only, the movements of the user are depicted as shaded triangles and open circles in FIG. 7 with north being oriented and displayed via an orientation compass 710. However, real time images may be illustrated in the augmented reality view depicted the movements of the user. Such real time images may be recorded and/or captured by the electronic device. The graphical movement log of the user 350 may be overlaid on an augmented reality view of the mapping 300. For example, the graphical movement log of the user 350 is overlaid on a floor plan of the data center 100 allowing the reviewer of the movements, activities, services provided to correlate motions with access to equipment.

Moreover, in one embodiment, an additional log history layer may be added to the mapping for any historical augmented reality history log of previous and/or simultaneous users of the data center 100. For example, the additional log history layer added to the mapping 300 may depict in real time any and all users in the data center 100 and the respective movements of each user. In other embodiments, all historical data relating to the data center 100 may be compared by the augmented reality module 214 and displayed on the electronic device in the additional log history layer for analysis and comparison.

For example, the user's 350 first movement 702 indicates the user 350 started moving north 45 feet in the data center 100. The second movement 704 of the user 350 indicates the user 350 turned right (east) and moved 50 feet in an eastern direction. Movement 706 indicates the user 350 turned southeast and moved 25 feet in an eastern direction. The user's 350 final movement 708 indicates the user 350 moved into a hazardous area. The augmented reality module 214 issues an alert (video and/or audio alert) in the augmented reality mapping 300 indicated the user 350 is in a hazardous area and notifies the user 350 to exit the hazardous area.

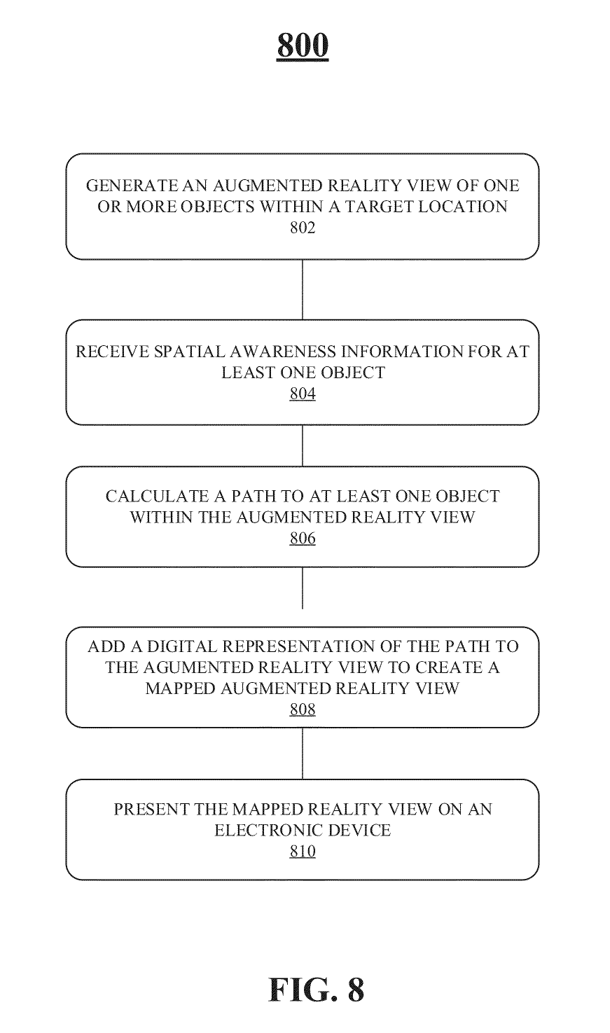

FIG. 8 illustrates an embodiment of a detailed logic flow 800 for providing augmented reality of a data center of FIGS. 1-3. In the illustrated embodiment shown in FIG. 8, the logic flow 800 may begin at block 802. An augmented reality view of one or more objects within a target location is generated at block 802. The target location representing a physical geographic location. The logic flow 800 receives spatial awareness information for at least one object at block 804. The spatial awareness may be both location and orientation of physical objects in a target location and/or data center. The logic flow 800 calculates a path to at least one object within the augmented reality view 806. The at least one object may be a computer device or a component of the computer device in a data center. The logic flow 800 moves to block 808. A digital representation of the path is added to the augmented reality view to create a mapped augmented reality view at block 808. The mapped augmented reality view is presented on an electronic device at block 810.

The embodiments are not limited to this example.

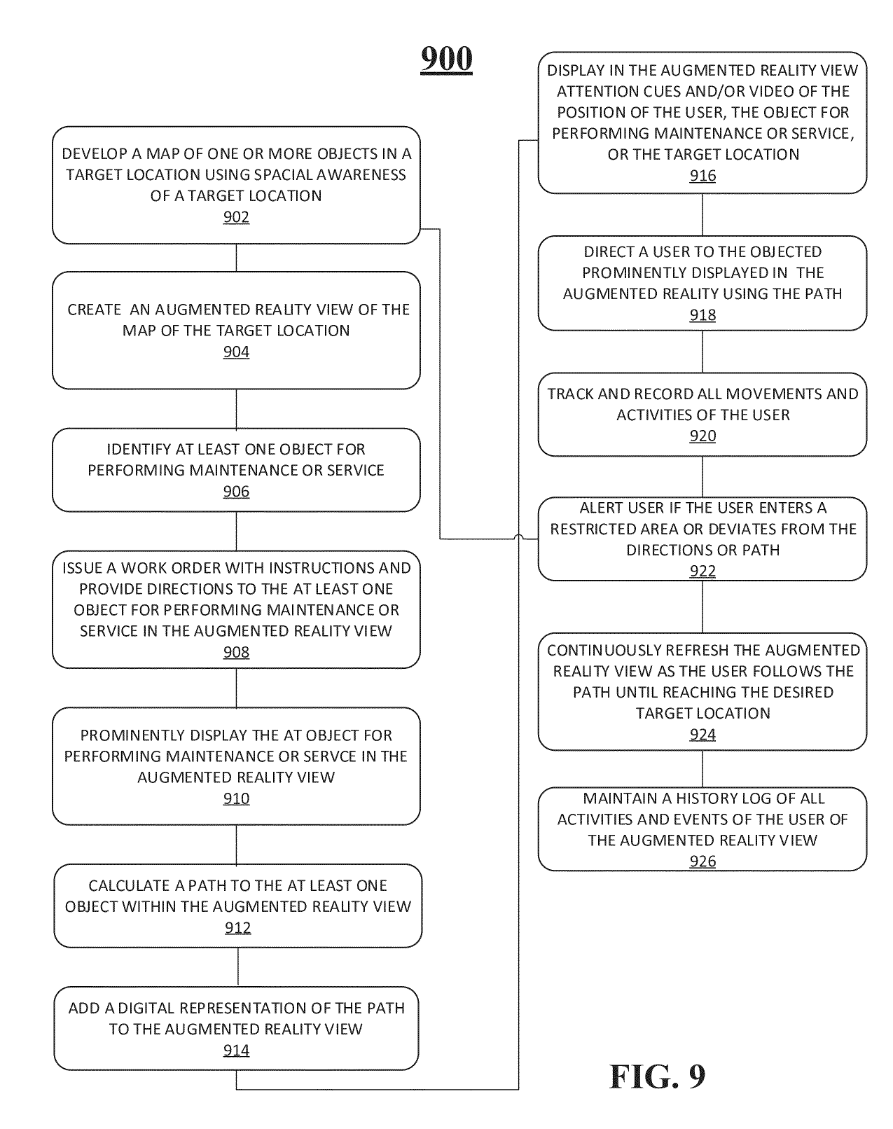

FIG. 9 illustrates an embodiment of a detailed logic flow 900 for providing an augmented reality view of a physical mapping and a network mapping of a data center of FIGS. 1-3. In the illustrated embodiment shown in FIG. 9, the logic flow 900 may begin at block 902. A map of one or more objects in a target location is created and developed using special awareness of the target location at block 902. Also, hazardous or other “keep-out” areas or equipment within the augmented reality view are also displayed with appropriate notation, directing the user to avoid them using environmental sensors 380, warning systems 382, audio/visual equipment 384, visual signs 312, and/or other features and computing components. In this way the user doesn't have to wait for the alert at block 922 and block 922 may work in conjunction with block 902.

The created map includes a physical geographical location map and a map of a computer network of a target location. The logic flow 900 moves to block 904. An augmented reality view of the map of the target location is created at block 904. At least one object for performing maintenance or service (such as those computer device or computer components as requiring or scheduled for maintenance or service) is identified at block 906. For example, a port located on a server is identified and detected as defective and is scheduled for repair or replacement.

The logic flow 900 moves to block 908. A work order with instructions and directions to the object for performing maintenance or service (such as those computer device or computer components requiring or scheduled for maintenance or service) is provided in the augmented reality view at block 908. The logic flow 900 moves to block 910. The object for performing maintenance or service (such as those computer device or computer components requiring or scheduled for maintenance or service) is prominently displayed in the augmented reality view of the target location at block 910. A path to the at least one object, such as the object requiring or scheduled for maintenance or service, is calculated with the augmented reality view at block 912. For example, using the navigational system 216 the spatial awareness of the object is determined. Next, one or more second locations are also determined. The second location may be one or more users having electronic devices in communication with the management module 220. The second location may be a fixed location having sensors that communicate geographical positions of the target locations and/or other objects in the target location, such as each exit, entrance, aisle, stairs, rooms, GPS coordinates, and/or level. Next, the distance between the object and the second location is calculated and determined. It should be noted that this calculation operation may be continuous and updated as the distance between the object and the second location vary, alter, and/or change.

The logic flow 900 moves to block 914. A digital representation of the path is added to the augmented reality view at block 914. Attention cues for the user and/or video (such as real-time video feeds) of the current position of the user, the object for performing maintenance or service (such as those computer device or computer components requiring or scheduled for maintenance or service), or the target location are provided in the augmented reality view at block 916. For example, the augmented reality module 214 may provide real-time video feeds of current position and location of the user or the object for performing maintenance or service (such as those computer device or computer components requiring or scheduled for maintenance or service) while following the path with the path being updated while the user traverse the path of the target location provided in the augmented reality view. Also, audio alerts may be communicated to the user, such as “stop, turn left and proceed east 100 feet.”

It should be noted that important part of the real-time nature of the augmented reality system is the ability to change goals based on circumstances. For example, if a more critical system requires service, the user 350 may be redirected away from the prior target location and instructed and/or directed toward a new target location, and returning to the prior target location when the higher-priority service for the new target location is complete. As an extreme example, in the case of an emergency, such as a fire, the augmented reality system described herein may direct the user to the nearest accessible fire exit as mentioned above.

The logic flow 900 moves to block 918.

A user is directed to the object that is prominently displayed in the augmented reality using the provided directions, path, attention cues, and/or audio and video communications at block 918. All movements and activities of the user are tracked while using the augmented reality view of the target location at block 920. Alerts may be issued if the user enters a restricted or hazardous area and/or if the navigational system 216 and the augmented reality module 214 detect and determine the user has deviated from the path or the directions at block 922. The augmented reality view is continuously refreshed as the user follows the path and/or directions until reaching the desired or identified object in the target location at block 924. A history log of all activities, movements, and events of the user and/or objects in the target location are maintained at block 926. For example, the augmented realty view may include a work order, directions, video, audio, and/or historical data relating to a computing device or component requiring or scheduled for maintenance or service.

The embodiments are not limited to this example.

Various embodiments provide for identifying one or more objects in the target location of a data center using one of multiple location-identification mechanism. Spatial awareness and information relating to the one or more objects in the target location is used for creating a mapping of a data center. One of the one or more objects requiring or scheduled for service is identified with the geographic position being detected. An augmented reality of the mapping of the data center is provided and used to direct a user to one of one or more objects requiring or scheduled for service or maintenance. Maintenance or service instructions are provided in the augmented reality for the computer devices requiring or scheduled for service or maintenance. Also, various options for displaying the augmented reality of the mapping are provided allowing a user to manipulate the augmented reality for selective viewing of the data center 100.

In one embodiment, the mapping includes a the direction to the geographic position, a physical and network mapping of the computer devices in the data center, a physical and network mapping of computer devices requiring or scheduled for service or maintenance, a network mapping of electrical or optical connection devices associated with the computer devices, and log information relating to movements of a user relating to the augmented reality. The augmented reality identifies and displays hazardous area and/or restricted regions of the data center and uses the augmented reality for directing the user away from the hazardous area or restricted regions. The mapping in the augmented reality may be continuously refreshed as a user traverses a directional path provided by the augmented reality.

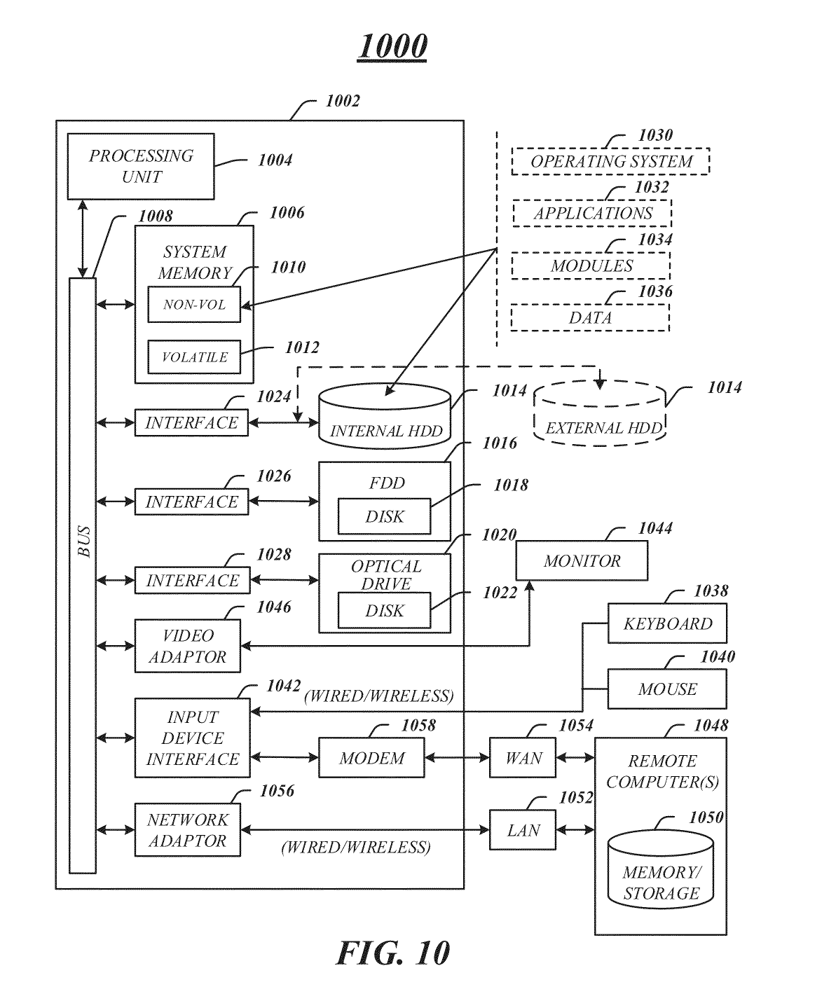

FIG. 10 illustrates an embodiment of an exemplary computing architecture 1300 suitable for implementing various embodiments as previously described. In one embodiment, the computing architecture 1000 may comprise or be implemented as part of an electronic device. Examples of an electronic device may include those described with reference to FIG. 1-9 among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the system 100.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

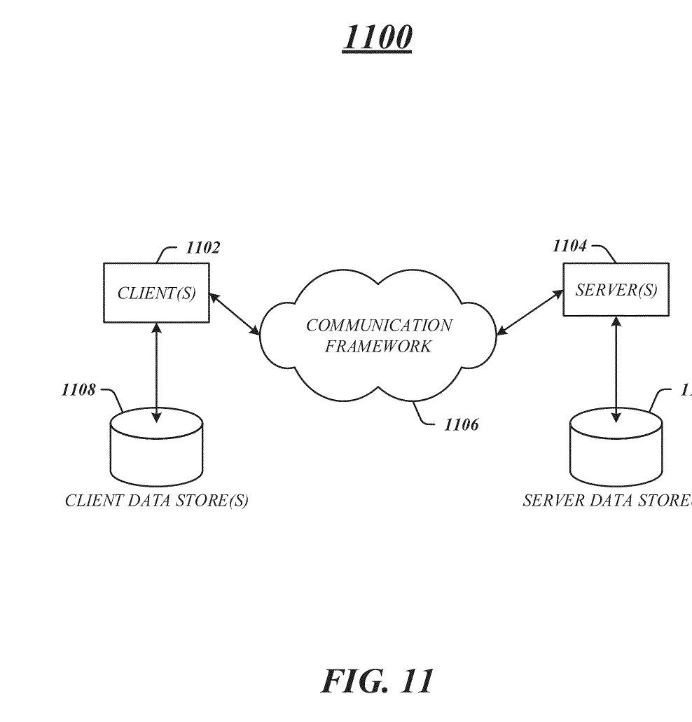

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1102 and servers 1104. The clients 1102 may implement the client device 910. The clients 1102 and the servers 1104 are operatively connected to one or more respective client data stores 1108 and server data stores 1110 that can be employed to store information local to the respective clients 1102 and servers 1104, such as cookies and/or associated contextual information.

The clients 1102 and the servers 1104 may communicate information between each other using a communication framework 1100. The communications framework 1100 may implement any well-known communications techniques and protocols. The communications framework 1100 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1100 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1102 and the servers 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general-purpose digital computers or similar devices.

Various embodiments also relate to apparatus or systems for performing these operations. This apparatus may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method, comprising:
generating an augmented reality view of one or more objects within a target location, the target location representing a physical geographic location;
receiving spatial awareness information for at least one object;
calculating a path to the at least one object within the augmented reality view;
adding a digital representation of the path to the augmented reality view to create a mapped augmented reality view; and
presenting the mapped augmented reality view on an electronic device.

2. The method of claim 1, comprising:
identifying the one or more objects in the target location using one of multiple location-identification mechanisms;
identifying the one or more objects for performing maintenance or service in the target location;
adding directions to the one or more objects in the mapped augmented reality view; and
adding maintenance or service instructions for the one or more objects in the mapped augmented reality view.

3. The method of claim 1, comprising adding to the augmented reality view a computer network mapping of the one or more objects, wherein the one ore more objects are computer devices and the computer network mapping includes at least each component of the one or more objects and electrical or optical connections to each of the one or more objects.

4. The method of claim 1, comprising:
identifying and displaying in the augmented reality view at least one of a hazardous area or restricted regions of the target location; and
using the mapped augmented reality view for directing a user away from the hazardous area or the restricted regions.

5. The method of claim 1, comprising prominently displaying the one or more objects for performing maintenance or service in the target location in the mapped augmented reality view.

6. The method of claim 1, comprising
determining spatial awareness information for at least one object using at least one of a global positioning satellite (GPS) device, a plurality of sensors, a radio frequency identification (RFID) device, a machine vision mechanism, a bar code, and an electric-field sensing component;
determining both a position and orientation of a user relative the one or more objects for performing maintenance or service in the target location using the GPS device, the plurality of sensors, the RFID device, the machine vision mechanism, the bar code, the electric-field sensing component, a gesture recognition device, a head tracker, an eye tracker, and a motion detection device;
tracking movements of the user in the target location;
adding the movements of the user to the mapped augmented reality view;
mapping the movements of the user to the path to the at least one object within the augmented reality view; and
providing alerts to the user while the user traverses the path to the at least one object within the augmented reality view.

7. The method of claim 1, comprising refreshing the mapping in the augmented reality to the one of the one or more objects for performing maintenance or service.

8. The method of claim 1, comprising:
maintaining historical data of a user relating to the augmented reality view of the one or more objects within a target location, wherein the historical data includes at least one of a log history, work orders, and movements and direction of the user relating to the mapping; and
issuing work orders relating to the one or more objects in the target location.

9. The method of claim 1, comprising building and maintaining a physical layout of the target location in a target location generator, wherein the target location generator includes a data center database and includes management tools.

10. An apparatus, comprising:
a processor circuit on a device;
a target location generator, having management tools, in association with and operative by the processor circuit, the target location generator operative on the processor circuit to build and maintain a physical geographic location and computer network mapping of a target location; and
an augmented reality component operative on the processor circuit, in communication with the target location generator, to execute an augmented reality service for the target location generator, the augmented reality component operative to:
generate an augmented reality view of one or more objects within the target location;
receive spatial awareness information for at least one object;
calculate a path to the at least one object within the augmented reality view;
add a digital representation of the path to the augmented reality view to create a mapped augmented reality view; and
present the mapped augmented reality view on an electronic device.

11. The apparatus of claim 10, the augmented reality component operative to:
identify the one or more objects in the target location using one of multiple location-identification mechanisms;
identify the one or more objects for performing maintenance or service in the target location;
prominently display the one or more objects for performing maintenance or service in the target location in the mapped augmented reality view;
add directions to the one or more objects in the mapped augmented reality view; and
issue and add maintenance or service instructions for the one or more objects in the mapped augmented reality view.

12. The apparatus of claim 10, the augmented reality component operative to add to the augmented reality view a computer network mapping of the one or more objects, wherein the one ore more objects are computer devices and the computer network mapping includes at least each component of the one or more objects and electrical or optical connections to each of the one or more objects.

13. The apparatus of claim 10, the augmented reality component operative to:
identify and display in the augmented reality view at least one of a hazardous area or restricted regions of the target location; and
use the mapped augmented reality view for directing a user away from the hazardous area or the restricted regions.

14. The apparatus of claim 10, the augmented reality component operative to:
determine spatial awareness information for at least one object using at least one of a global positioning satellite (GPS) device, a plurality of sensors, a radio frequency identification (RFID) device, a machine vision mechanism, a bar code, and an electric-field sensing component;
determine both a position and orientation of a user relative the one or more objects for performing maintenance or service in the target location using the GPS device, the plurality of sensors, the RFID device, the machine vision mechanism, the bar code, the electric-field sensing component, a gesture recognition device, a head tracker, an eye tracker, and a motion detection device;
track movements of the user in the target location;
add the movements of the user to the mapped augmented reality view;
map the movements of the user to the path to the at least one object within the augmented reality view;
provide alerts to the user while the user traverses the path to the at least one object within the augmented reality view;
refresh the mapping in the augmented reality to the one of the one or more objects for performing maintenance or service; and
maintain historical data of a user relating to the augmented reality view of the one or more objects within a target location, wherein the historical data includes at least one of a log history, work orders, and movements and direction of the user relating to the mapping.

15. At least one non-transitory computer-readable storage medium comprising instructions that, when executed, cause a system to:
generate an augmented reality view of one or more objects within a target location;
receive spatial awareness information for at least one object;
calculate a path to the at least one object within the augmented reality view;
add a digital representation of the path to the augmented reality view to create a mapped augmented reality view; and
present the mapped augmented reality view on an electronic device.

16. The computer-readable storage medium of claim 15, comprising further instructions that, when executed, cause a system to:
identify the one or more objects in the target location using one of multiple location-identification mechanisms;
identify the one or more objects for performing maintenance or service in the target location;
prominently display the one or more objects for performing maintenance or service in the target location in the mapped augmented reality view;
add directions to the one or more objects in the mapped augmented reality view; and
issue and add maintenance or service instructions for the one or more objects in the mapped augmented reality view.

17. The computer-readable storage medium of claim 16, comprising further instructions that, when executed, cause a system to add to the augmented reality view a computer network mapping of the one or more objects, wherein the one ore more objects are computer devices and the computer network mapping includes at least each component of the one or more objects and electrical or optical connections to each of the one or more objects, log information relating to movements of a user relating to the augmented reality.

18. The computer-readable storage medium of claim 15, comprising further instructions that, when executed, cause a system to:
identify and display in the augmented reality view at least one of a hazardous area or restricted regions of the target location; and
use the mapped augmented reality view for directing a user away from the hazardous area or the restricted regions.

19. The computer-readable storage medium of claim 15, comprising further instructions that, when executed, cause a system to:
determine spatial awareness information for at least one object using at least one of a global positioning satellite (GPS) device, a plurality of sensors, a radio frequency identification (RFID) device, a machine vision mechanism, a bar code, and an electric-field sensing component;
determine both a position and orientation of a user relative the one or more objects for performing maintenance or service in the target location using the GPS device, the plurality of sensors, the RFID device, the machine vision mechanism, the bar code, the electric-field sensing component, a gesture recognition device, a head tracker, an eye tracker, and a motion detection device;
track movements of the user in the target location;
add the movements of the user to the mapped augmented reality view;
map the movements of the user to the path to the at least one object within the augmented reality view;
provide alerts to the user while the user traverses the path to the at least one object within the augmented reality view; and
refresh the mapping in the augmented reality to the one of the one or more objects for performing maintenance or service.

20. The computer-readable storage medium of claim 15, comprising further instructions that, when executed, cause a system to maintain historical data of a user relating to the augmented reality view of the one or more objects within a target location, wherein the historical data includes at least one of a log history, work orders, and movements and direction of the user relating to the mapping.
